(19) United States
(12) Patent Application Publication
(10) Pub. No.: US 2005/0199160 A1
(43) Pub. Date: Sep. 15, 2005

(54) Flute tube and joint structure thereof

(76) Inventor: Wang Ching-Po, Changhua-Hsien (TW)

Correspondence Address: MERCHANT & GOULD PC, P.O. BOX 2903, MINNEAPOLIS, MN, 55402-0903, US

(21) Appl. No.: 10/800,072

(22) Filed: Mar. 11, 2004

(51) Int. Cl. A47B 9/00; G10D 7/00

(52) U.S. Cl. 108/107

(57) ABSTRACT

A flute tube (20) includes a metal tube body. The metal tube body is flute-shaped. A plurality of dents, holes, or protrudings (21) is formed on the metal tube body in a predetermined arrangement. A joint structure of the flute tube further includes a liner (30) and a sleeve (40). The liner is sandwiched between the sleeve and the metal tube body for fastening and positioning the sleeve. A shelf (50) for depositing goods or clothing, which includes the joint structure, further have a frame (51) fixed on the sleeve.

### BACKGROUND OF THE INVENTION

1. Field of the Invention

The present invention relates to a tube structure, and particularly to a flute tube and a joint structure thereof.

2. Description of Related Art

Nowadays, various tubes exist in the market. Traditional metal tubes constitute a shelf for depositing goods or clothings as shown in FIG. 9 and FIG. 10. The metal tubes are used as foot tubes 11, on which are uniformly incised rounded grooves 12. The distance between two neighboring grooves 12 is h. Frames 15 are supported by the foot tubes 11 and are positioned thereon through sleeves 16 being inserted over the tubes 11. A liner 14, sandwiched between the periphery of the tube 11 and the sleeve 16, is composed of two halve, each half defining a protruding ring 13 therein for inserting in one rounded groove 12. However, because rounded grooves 12 are incised on the foot tubes 11, the rigidity thereof is weakened. Furthermore, the position of the frame 15 can only be adjusted over a distance of n×h, wherein n is an integer.

Therefore, an improved structure of a flute tube and a joint structure thereof is desired which overcomes the disadvantages of the prior art.

### SUMMARY OF THE INVENTION

A main object of the present invention is to provide a flute tube, which has a beautiful appearance and good rigidity.

Another object of the present invention is to provide a joint structure of a flute tube, which is more convenient for adjusting its structure.

A third object of the present invention is to provide a shelf for depositing goods or clothings.

To obtain the above objections, a flute tube of the present invention comprises a metal tube body, wherein the metal tube body is flute-shaped. A plurality of dents, holes, or protrudings is formed on the metal tube body in a predetermined arrangement.

A joint structure of a flute tube of the present invention, comprises a metal tube body, a liner, and a sleeve, wherein the metal tube body is flute-shaped. A plurality of dents, holes, or protrudings is formed on the metal tube body in a predetermined arrangement. The liner is sandwiched between the sleeve and the metal tube body for fastening and positioning the sleeve.

A shelf of the present invention for depositing goods or clothings, comprise a metal tube body, a frame, a liner, and a sleeve, wherein the metal tube body is flute-shaped. A plurality of dents, holes, or protrudings is formed on the metal tube body in a predetermined arrangement. The liner is sandwiched between the sleeve and the metal tube body. The frame is fixed on the sleeve, thereby being supported on the metal tube body.

Other objects, advantages and novel features of the invention will become more apparent from the following detailed description of a preferred embodiment thereof when taken in conjunction with the accompanying drawings, wherein:

### BRIEF DESCRIPTION OF THE DRAWINGS

FIG. 1 is a front view of a flute tube in accordance with an embodiment of the present invention;

FIG. 2 is a back view of the flute tube of FIG. 1;

FIG. 3 is a plan view of a liner with an embodiment of the present invention;

FIG. 4 is a disassembled, plan view of a joint structure of the flute tube in accordance with an embodiment of the present invention;

FIG. 5 is a schematic diagram of one position of the joint structure of FIG. 4;

FIG. 6 is a schematic diagram of another position of the joint structure of FIG. 4;

FIG. 7 is a perspective view of a shelf in accordance with an embodiment of the present invention;

FIG. 8 is a plan view of a flute tube in accordance with another embodiment of the present invention;

FIG. 9 is a perspective view of a shelf of prior art; and

FIG. 10 is an exploded view of FIG. 9.

### DETAILED DESCRIPTION OF THE INVENTION

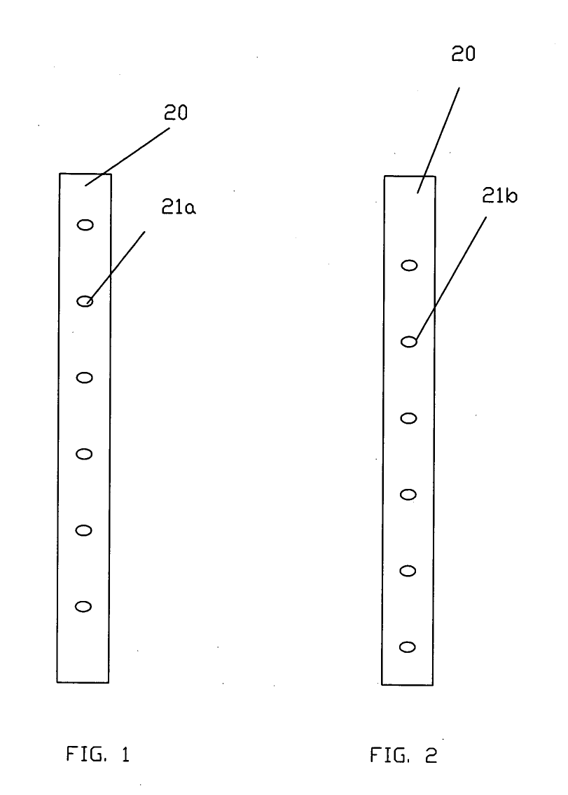

Referring now to the drawings in detail, FIG. 1 and FIG. 2 show a flute tube 20. The flute tube 20 is substantially metal tube, such as stainless steel, copper, aluminum, titanium, or the alloy thereof, thus it looks very noble and fine. Two rows of dents 21 (21a and 21b) are defined on the periphery of the flute tube 20. The two rows of dents 21 are respectively and symmetrically arranged in both a front surface, which is designated as 21a, and a back surface of the flute tube 20, which is designated as 21b. The distance between each two neighboring dents 21 in the same row is h. Each dent 21b on the back surface is located in the middle of two corresponding dents 21a on the front surface, thus two corresponding dents 21a and 21b are spaced over a distance of h/2. Therefore, the tube 20 looks like a flute, and very beautiful.

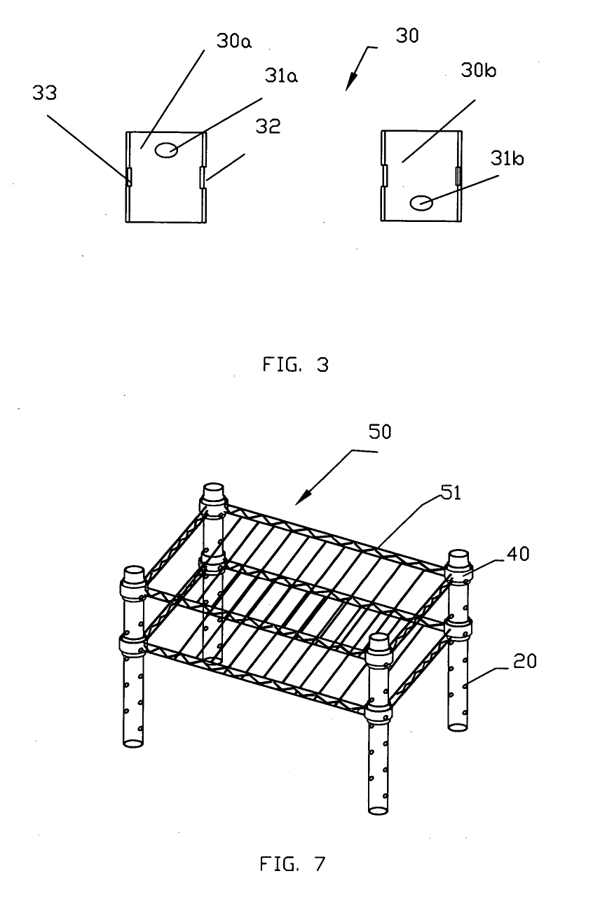

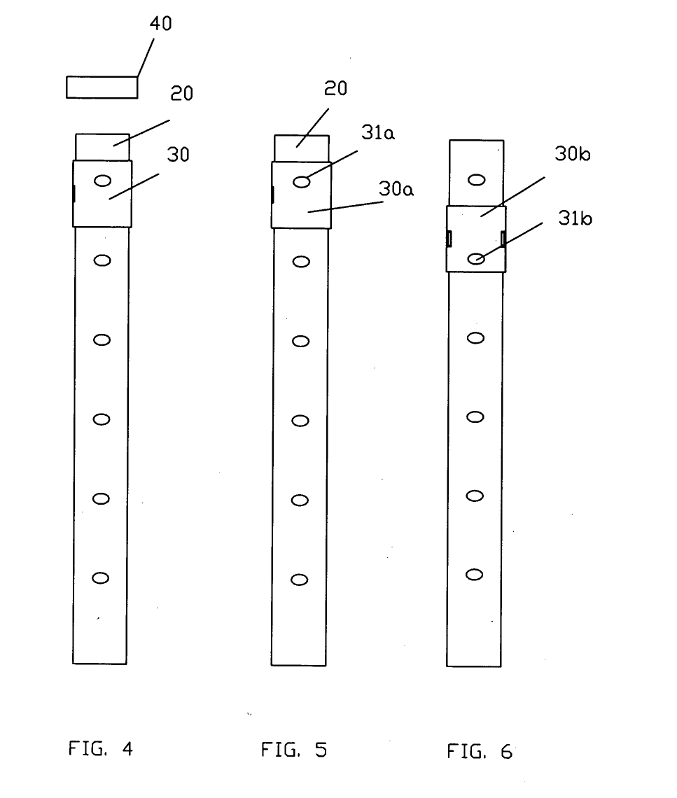

When the flute tube 20 of the present invention is used to constitute a shelf (as shown in FIG. 7), some other joint elements are needed, such as a liner 30 and a sleeve 40, referring to FIG. 3 and FIG. 4. The liner 30, which is cone-shaped, specifically, a lower diameter thereof being greater than an upper diameter, includes two halve 30a and 30b. Wherein, the half 30a forms a protruding 31a on the middle top therein, while the half 31b forms a protruding 31b on the middle bottom therein. The distance between the protrudings 31a and 31b is h/2. Each half of liner 30 respectively defines a cutout 33 and forms a flange 32 at two side flanks (not labeled) thereof. The flanges 32 and the cutouts 33 are in a rectangular shape, but other shapes are also applicable.

The sleeve 40 is a circular fastening element. An inside diameter of the sleeve 40 is equal or slightly greater than an outside diameter of the liner 30.

When assembling, the liner 30 is set over the periphery of the flute tube 20, and the protruding 31 is inserted in the dent 21, specifically, the protruding 31a is inserted in the dent 21a on the front surface of the flute tube 20, the protruding 31b is inserted in the dent 21b. The flanges 32 of the liner 30a and 30b are respectively clamped in the cutouts 33 one another. The sleeve 40 is inserted over and tightly clamped on the periphery of the liner 30. Because frames are soldered on the sleeve 40, they are supported and positioned on the flute tube 20. Since the liner 30 is cone-shaped, the sleeve 40 can tightly support the frame thereon, and cannot slide downwardly.

When using the flute tube 20 of the present invention as foot tube to support frames, the frames are soldered on the sleeve 40. The sleeve 40 is inserted over the flute tube 20 for positioning the frames. Users can adjust the height of the frames if desired. Referring to FIG. 5 and FIG. 6, wherein, when the frame (not shown) is positioned at a first position at a height of the first dent 21a, the protruding 31a of the liner 30a is embedded in the first dent 21a on the front surface, and the protruding 31b is embedded in the first dent 21b on the back surface (see FIG. 5). If the user wants to move the frame down a distance of (n×h), then move directly down and position the protruding 31a of the liner 30 at the (n+1) dent 21a. If exchange the two halve 30a and 30b of the liner 30 and reverse the half 30b from top to bottom, the protruding 31b is embedded into the second dent 20a on the front surface, and the protruding 31a is inserted into the first dent 20b on the back surface of the flute tube 20, the frame supported by the sleeve 40 over the liner 30 will be moved down a distance of h/2 along the flute tube 20 relative to the first position (see FIG. 6). However, the traditional tube for supporting frame cannot be adjusted over a distance of h/2.

The flute tube 20 of the present invention is used as foot tube to assemble a shelf 50 as shown in FIG. 7. Frames 51 are soldered on the sleeves 40 at the corners thereof, and are positioned on the flute tube 20 as described above. Since the liner 30 is cone-shaped, the frames 51 are tightly supported and cannot slide down. If the user needs to adjust the height of the frame 51, he or she just knocks at the bottom of the frame 51 near the sleeves 40 upwardly, therefore, the sleeves 40 depart from the liners 30, and the frame 51 is loosed from the original position. The frame 51 is re-positioned at a desired height using the same method as described above. The frames 51 can also be made of the flute tube 20 of the present invention, so the appearance of the shelf 50 keeps perfect harmony.

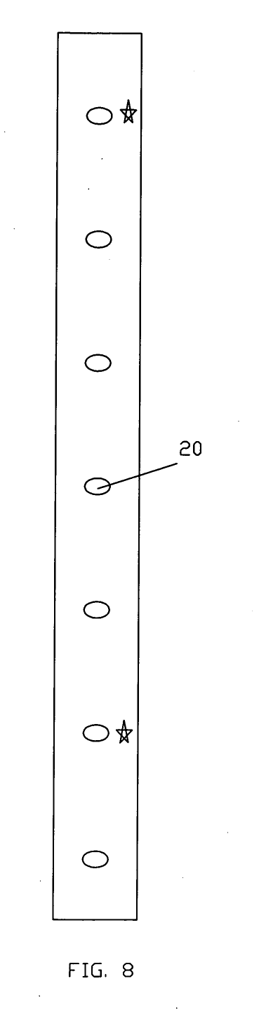

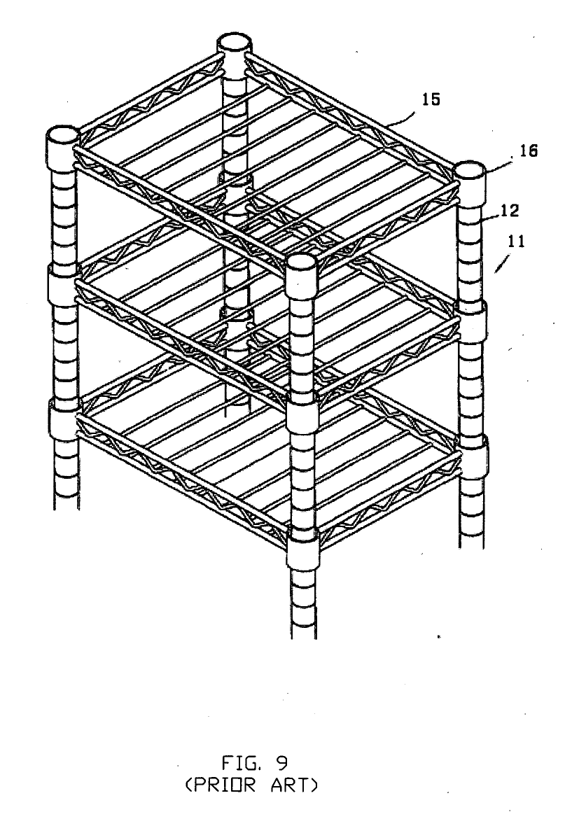

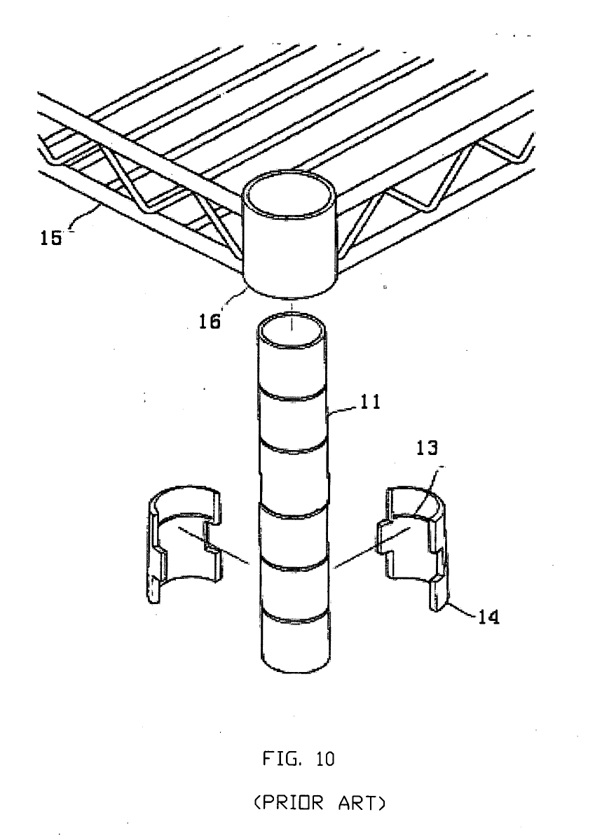

When a very long flute tube 20 is used, it is not convenient to measure the length and position the frame. This problem will be resolved in the following preferred embodiment. Referring to FIG. 8, at each predetermined distance, a mark is set on the surface of the flute tube 20. For example, if the distance h between two neighboring dents in the same row is equal to 2 inches, a pentagram mark will be set beside the dent 21 to represent a distance of 10 inches. As shown in FIG. 8, two pentagrams are respectively set beside the first dent 21a and the sixth dent 21a. A quincunx, line, symbol or other shaped pattern, or letters can be used as a mark. Therefore, the user can learn the length of the flute tube 20 by counting the marks. Furthermore, it is more convenient for precisely positioning the frame referring to the marks.

The dents 21 on the flute tube 20 can be replaced by through holes penetrating the tube wall. The shape of the dents or holes 21 can be circular, rectangular, diamond, pentagram, quincunx, irregular etc.

Only one row of dents or holes 21 or more than two rows can be set on the flute tube 20. The dents or holes 21 can be arranged in equidistance or not, and can be arranged in a curve or a helical line.

The dents or holes 21 formed on the flute tube 20 can also be designed as protrudings, while the protrudings 31 in the liner 30 must be correspondingly designed as dent or hole for receiving the protrudings of flute tube 20.

The flute tube 20 of the present invention can be used to assemble other furniture, such as desks or chairs, or used in the industry.

It is understood that the invention may be embodied in other forms without departing from the spirit thereof. Thus, the present examples and embodiments are to be considered in all respects as illustrative and not restrictive, and the invention is not to be limited to the details given herein.

1. A flute tube comprising a metal tube body, wherein the metal tube body is flute-shaped, a plurality of dents, holes, or protrudings is formed on the metal tube body in a predetermined arrangement.

2. The flute tube as claimed in claim 1, wherein the shape of the plurality of dents, holes, or protrudings is circular, rectangle, diamond, pentagram, or quincunx, or irregular.

3. The flute tube as claimed in claim 1, wherein the plurality of dents, holes, or protrudings is arranged in line, in curve, or in a helical line on the metal tube body.

4. The flute tube as claimed in claim 3, wherein the plurality of dents, holes, or protrudings is arranged in two lines, which are respectively on a front surface and a back surface of the metal tube body.

5. The flute tube as claimed in claim 4, wherein the plurality of dents, holes, or protrudings in each line is arranged in equidistance.

6. The flute tube as claimed in claim 5, wherein each dent, hole, or protruding on the back surface of the metal tube body is located at the middle of two corresponding dents, holes, or protrudings on the front surface.

7. The flute tube as claimed in claim 1, wherein a mark is formed on the metal tube body for designing a predetermined distance.

8. A joint structure of a flute tube, comprising:
a metal tube body;
a liner; and
a sleeve; wherein
the metal tube body is flute-shaped, a plurality of dents, holes, or protrudings is formed on the metal tube body in a predetermined arrangement, the liner is sandwiched between the sleeve and the metal tube body for fastening and positioning the sleeve.

9. The joint structure of a flute tube as claimed in claim 8, wherein said liner forms a protruding therein for inserting in said dent or hole on the metal tube body, or forms a dent or hole for receiving said protruding on the metal tube body.

10. The joint structure of a flute tube as claimed in claim 9, wherein the plurality of dents, holes, or protrudings is arranged in line, in curve, or in a helical line on the metal tube body.

11. The joint structure of a flute tube as claimed in claim 10, wherein the plurality of dents, holes, or protrudings is arranged in two lines which are respectively on a front surface and a back surface of the metal tube body, said liner is composed of two halve, and each half forms a protruding therein.

12. The joint structure of a flute tube as claimed in claim 11, wherein the plurality of dents, holes, or protrudings in each line is arranged in equidistance of h.

13. The joint structure of a flute tube as claimed in claim 12, wherein each dent, hole or protruding on the back surface of the metal tube body is located at the middle of two corresponding dents, holes, or protrudings on the front surface, one half of said liner forms a protruding, or dent or hole on a middle bottom thereof, the other half forms a protruding, or dent or hole on a middle top thereof, and the distance between the two protrudings is half of the h.

14. The joint structure of a flute tube as claimed in claim 9, wherein a mark is formed on the metal tube body for designing a predetermined distance.

15. A shelf for depositing goods or clothings, comprising a metal tube body;
a metal tube body;
a frame;
a liner; and
a sleeve; wherein
the metal tube body is flute-shaped, a plurality of dents, holes, or protrudings is formed on the metal tube body in a predetermined arrangement, the liner is sandwiched between the sleeve and the metal tube body, the frame is fixed on the sleeve, thereby the frame is supported on the metal tube body.

16. The shelf as claimed in claim 15, wherein said liner forms a protruding therein for inserting in said dent or hole on the metal tube body, or forms a dent or hole for receiving said protruding on the metal tube body.

17. The shelf as claimed in claim 16, wherein the plurality of dents, holes, or protrudings is arranged in line, in curve, or in a helical line on the flute tube.

18. The shelf as claimed in claim 17, wherein the plurality of dents, holes, or protrudings is arranged in two lines which are respectively on a front surface and a back surface of the metal tube body, said liner is composed of two halve, and each half forms a protruding therein.

19. The shelf as claimed in claim 18, wherein the plurality of dents, holes, or protrudings in each line is arranged in equidistance of h.

20. The shelf as claimed in claim 19, wherein each dent, hole or protruding on the back surface of the metal tube body is located at the middle of two corresponding dents, holes, or protrudings on the front surface, one half of said liner forms a protruding, or dent or hole on a middle bottom thereof, the other half forms a protruding, or dent or hole on a middle top thereof, and the distance between the two protrudings is half of the h.
